(19) United States
(12) Patent Application Publication
(10) Pub. No.: US 2010/0178434 A1
(43) Pub. Date: Jul. 15, 2010

(54) CONDUCTIVE INK COMPOSITION FOR PRINTED CIRCUIT BOARD AND METHOD OF PRODUCING PRINTED CIRCUIT BOARD

(75) Inventors: Jong-Hee Lee, Suwon-si (KR); Jae-Myung Kim, Suwon-si (KR); Kyu-Nam Joo, Suwon-si (KR); So-Ra Lee, Suwon-si (KR); Jae-Sun Jeong, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/641,176

(22) Filed: Dec. 17, 2009

(30) Foreign Application Priority Data
Jan. 9, 2009 (KR) 10-2009-0001911

(51) Int. Cl. B05D 3/06; B05D 5/12; H01B 1/02; H01B 1/12

(52) U.S. Cl. 427/551; 252/520.3; 252/519.33

(57) ABSTRACT

Disclosed is a conductive ink composition for a flexible printed circuit (FPC), and a method of producing a printed board using the same. The conductive ink composition for a flexible printed circuit (FPC) includes a Ag-containing compound, a dispersion stabilizer, and a solvent.

### CROSS-REFERENCE TO RELATED APPLICATIONS

This application claims priority to and the benefit of Korean Patent Application No. 10-2009-0001911 filed in the Korean Intellectual Property Office on Jan. 9, 2009, the entire contents of which are incorporated herein by reference.

### BACKGROUND OF THE INVENTION

1. Field of the Invention

This disclosure relates to a conductive ink composition for a flexible printed circuit (FPC) and a method of producing a printed circuit board using the conductive ink composition.

2. Description of the Related Art

A flexible printed circuit board (FPC) used for various electronic devices such as mobile phones, PDAs, laptop computers, and the like and a printed circuit board used for business, office, or home electronic devices are fabricated in a lithography method, a deposition process, or the like. However, these processes are complex and require expensive equipment. In addition, as an electronic device becomes thinner and smaller, a flexible printed circuit (FPC) requires high density and high integration so that the flexible printed circuit (FPC) is required to be fine, in which a wire width and a pitch between the wires become narrow.

Conductive metal ink may mainly includes a Ag nano-ink. This Ag nano-ink is prepared in the following process. First, nano-sized Ag particles are prepared from atom units of particles in a chemical reduction method. They are separated and dried, and then redispersed with a dispersing agent in a solvent. In addition, the dispersion solution is mixed with various additives considering smooth ink discharge factors such as viscosity, surface tension, wetness, and the like, preparing a Ag nano-ink.

The Ag nano-ink is used to fabricate a fine wire in a common inkjet method, in which ink is discharged on a substrate and heat-treated. However, a conventional Ag nano-ink has a problem of decreasing ink life-span due to growth or agglomeration of Ag nanoparticles clogging a nozzle of a printing head when discharged, and the like. Accordingly, the Ag nano-ink may be filtrated in order to solve this problem. However, there is a problem of losing material since agglomerated Ag nanoparticles are removed during the filtration. In addition, after the filtration, there is a problem of lack of control of the amount of Ag nanoparticles in the ink solution.

### SUMMARY OF THE INVENTION

One aspect of this disclosure provides a conductive ink composition for a flexible printed circuit (FPC) having no problem of agglomeration and the like despite long-term storage.

Another aspect of this disclosure provides a method of producing a printed board using the conductive ink composition.

Aspects of this disclosure are not limited to the above technical purposes, and a person of ordinary skill in the art can understand other technical purposes.

Yet another aspect of this disclosure provides a conductive ink composition for a flexible printed circuit (FPC), which includes a Ag-containing compound, a dispersion stabilizer, and a solvent.

According to one aspect of this disclosure, provided is a method that includes coating the conductive ink composition on a substrate, radiating electron beams on the substrate coated with the conductive ink composition, and heat-treating the radiated substrate.

Hereinafter, further aspects of this disclosure will be described in detail.

Since the conductive ink composition for a flexible printed circuit (FPC) is not agglomerated despite long-term storage, it has no life-span decrease problem. When it is used to fabricate a flexible printed circuit (FPC), there is no problem of clogging a nozzle and the like. Accordingly, it may be easily applied to fabricate a flexible printed circuit (FPC).

### BRIEF DESCRIPTION OF THE DRAWINGS

FIG. 1 is an electron microscope photograph showing a fine wire according to a first embodiment.

FIG. 2 is an electron microscope photograph showing a fine wire according to Comparative Example 1.

### DETAILED DESCRIPTION OF THE INVENTION

Exemplary embodiments of this disclosure will hereinafter be described in detail. However, these embodiments are only exemplary, and this disclosure is not limited thereto.

According to the first embodiment, a conductive ink composition for a flexible printed circuit (FPC) includes a Ag-containing compound, a dispersion stabilizer, and a solvent.

The Ag-containing compound may be selected from AgCl, AgNO₃, AgClO₄, Ag₂SO₄, AgBF₄, CH₃COOAg, or combinations thereof. The Ag-containing compound is present in the form of Ag⁺ ions by being dissolved in the composition and becoming dispersed. The Ag⁺ ions are reduced to Ag by radiating electron beams after the composition is coated on a substrate. The Ag-containing compound may be included in the conductive ink composition in an amount of from about 10 to about 35 wt % based on the entire weight of the composition, or in an amount of from about 19 to about 25 wt %. When the Ag-containing compound is included within the range, water is decomposed by electron beam radiation producing OH radicals, with which the ions are reduced to Ag.

The dispersion stabilizer may be selected from polyvinylalcohol, polyvinyl pyrrolidone, polyethylene glycol, polyacrylic acid, polymethylmethacrylate, polyacrylamide, or combinations thereof. The dispersion stabilizer prevents a Ag-containing compound from agglomerating and keeping it uniformly dispersed. In addition, it suppresses reduced Ag from agglomeration or particle growth during the electron beam radiation.

The dispersion stabilizer may be included in the conductive ink composition in an amount of from about 2 to about 10 wt % based on the entire weight of the composition, or in an amount of from about 4 to about 7 wt %. When it is included within the range, it may impart a composition with sufficient three-dimensional stability during ink discharge and no negative influence on reduction speed during the reduction, and may help it to maintain appropriate viscosity at which uniform particles may be produced.

The solvent may be selected from water, ethanol, isopropyl alcohol, ethylene glycol, or combinations thereof. The solvent is decomposed during the electron beam radiation and forms OH radicals. The OH radicals produce a radical of the dispersion stabilizer and thereby reduce a Ag-containing compound to Ag. In addition, when the solvent includes water and isopropyl alcohol together, it may produce an OH radical. This OH radical suppress re-oxidation of Ag. If a conductive ink composition for a flexible printed circuit (FPC) according to the first embodiment includes a reducing agent, it may not produce OH radicals.

The solvent may be included in an amount of from about 50 to about 80 wt % based on the entire weight of the composition, or in an amount of from about 65 to about 75 wt %. When the solvent is included within the range, it may dissolve a solute well and produce an appropriate number of reduced particles on a substrate, forming a wire with an appropriate thickness. Accordingly, there is no problem of increasing wire resistance when forming a thin wire.

The conductive ink composition does not include Ag as a metal (i.e., Ag⁰), but includes a Ag-containing compound (Ag⁺). When it includes Ag as a metal, it may have the problem of agglomeration among the particles or particle size growth during long-term storage. Accordingly, a conductive ink composition according to one embodiment may be usefully applied to a fine wire in a flexible printed circuit (FPC) after long-term storage. It may not cause a problem in equipment for forming a fine wire, in particular, a problem of clogging a nozzle and the like.

According to one embodiment, a conductive ink composition can be usefully applied to a flexible printed circuit (FPC).

Another embodiment provides a method of fabricating a flexible printed circuit (FPC) using the conductive ink composition.

First, a conductive ink composition according to one embodiment is coated on a substrate.

The conductive ink composition has the aforementioned composition, but the mixing order may be changed. However, a conductive ink composition may be prepared by adding a dispersion stabilizer to a solvent to prepare a stable dispersion solution, and then adding a Ag-containing compound thereto.

The coating method may include any coating method used for a flexible printed circuit (FPC), for example an inkjet method, a screening method, and the like. In one embodiment, the inkjet method is preferred.

The substrate may include any substrate used to fabricate a flexible printed circuit (FPC). For example, it may include a resin film, polytetrafluoroethylene or polyimide, or may be a glass substrate.

The substrate coated with an ink composition is radiated by electron beams. The electron beam may have from about 0.5 to about 0.7 MeV of electron beam energy and a radiation amount from about 30 to about 50 kGy. When the electron beam energy and radiation amount are within the ranges, it may bring about a reduction reaction at an appropriate speed, preparing uniform particles.

In some embodiments, the electron beam decomposes the solvent, forming electrons and OH radicals. This OH radicals produce polyvinyl alcohol (H), a dispersion stabilizer, into polyvinyl alcohol (.) as shown in the following Formulas 1 and 2, and reduces Ag⁺ ions of a Ag-containing compound into Ag⁰ in an ink composition, resultantly transforming Ag⁺ ions with an Å radius into Ag⁰ nanoparticles.

The following Formulas 1 and 2 show polyvinyl alcohol as the dispersion stabilizer, but the dispersion stabilizer is not limited thereto.

polyvinylalcohol(H)+OH.→polyvinylalcohol(.)+H₂O [Reaction Scheme 1]

Ag⁺+e⁻/polyvinyl alcohol(.)→Ag⁰ [Reaction Scheme 2]

The substrate radiated by electron beams is heat-treated, fabricating a flexible printed circuit (FPC). The heat treatment removes residual carbon due to an organic material, forming a fine Ag wire on the substrate.

The heat treatment may be performed at from about 190 to about 250° C. When the heat treatment process is performed within the range, a layer may be more densely and minutely formed, and it may decompose an organic material that may increase resistance of a wire so that the organic material may not be included in the wire. The heat treatment may be performed for from about 20 to about 40 minutes. When heat treated for a time within this range, a layer may be more dense.

The aforementioned method of fabricating a flexible printed circuit (FPC) includes formation of a fine wire by using a Ag-containing compound to produce Ag nanoparticles on a substrate. Since a conductive ink including the Ag nanoparticles is prevented from agglomeration among the particles or growth thereof, it may solve a problem in a coating device, and a problem of clogging the nozzle of an inkjet head and decreasing ink life-span.

The following examples illustrate this disclosure in more detail. These examples, however, are not in any sense to be interpreted as limiting the scope of this disclosure.

### Example 1

A liquid dispersion stabilizer was prepared by adding 11 parts by weight of polyvinyl alcohol to 100 parts by weight of distilled water. Next, 11 parts by weight of isopropyl alcohol were added to the liquid dispersion stabilizer and 40 parts by weight of AgNO₃ were mixed therewith, preparing a conductive ink composition. In this conductive ink composition, Ag in the AgNO₃ was dispersed as Ag⁺ ions.

The ink composition was discharged with an inkjet device and coated on a glass substrate. Then, an electron beam with a radiation amount of 50 kGy and electron beam energy of 0.7 MeV was radiated on the substrate coated with the ink composition. The electron beam radiation reduced Ag⁺ into Ag⁰, thereby producing Ag nanoparticles on the substrate.

After the electron beam radiation, the substrate was heat-treated at 200° C. in an electric furnace, fabricating a flexible printed circuit (FPC) having fine wires.

### Comparative Example 1

A liquid dispersion stabilizer was prepared by adding 11 parts by weight of polyvinyl alcohol to 100 parts by weight of distilled water. Next, 40 parts by weight of a Ag metal nanoparticles with an average size of 5.9 nm were mixed the above solution, preparing a conductive ink composition.

The ink composition was discharged with an inkjet device and coated on a glass substrate. The substrate was heat-treated at 200° C. in an electric furnace, fabricating a flexible printed circuit (FPC) having fine wires.

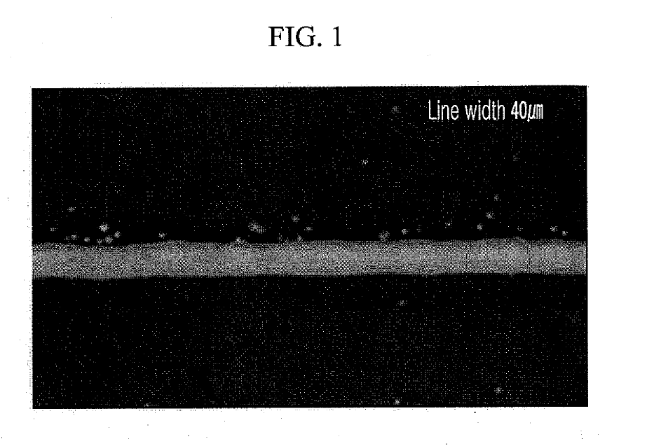

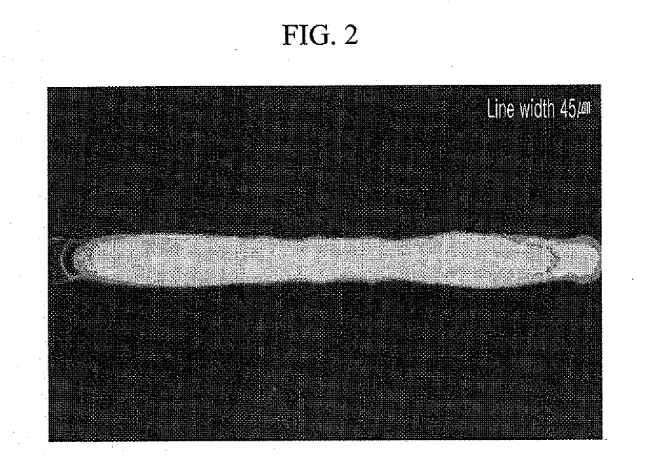

The fine wires according to Example 1 and Comparative Example 1 are respectively shown in FIGS. 1 and 2. As shown in FIG. 1, the fine wire formed a clear 40 μm wide line. On the contrary, as shown in FIG. 2, the fine wire according to Comparative Example 1 formed a 45 μm-wide line, which is thicker than that of Example 1. As a result, the conductive ink composition prepared according to Example 1 may be appropriately applied to an area requiring an ultrafine wire.

While this disclosure has been described in connection with what is presently considered to be practical exemplary embodiments, it is to be understood that the present embodiments are not limited to the disclosed embodiments, but, on the contrary, is intended to cover various modifications and equivalent arrangements included within the spirit and scope of the appended claims. Therefore, the aforementioned embodiments are to be understood to be exemplary but not limiting this disclosure in any way.

What is claimed is:

1. A conductive ink composition for a flexible printed circuit (FPC), comprising:
a Ag-containing compound;
a dispersion stabilizer; and
a solvent.

2. The conductive ink composition of claim 1, wherein the Ag-containing compound is selected from the group consisting of AgCl, AgNO₃, AgClO₄, Ag₂SO₄, AgBF₄, CH₃COOAg, and combinations thereof.

3. The conductive ink composition of claim 1, wherein the dispersion stabilizer is selected from the group consisting of polyvinyl alcohol, polyvinyl pyrrolidone, polyethylene glycol, polyacrylic acid, and combinations thereof.

4. The conductive ink composition of claim 1, wherein the solvent is selected from the group consisting of water, ethanol, isopropyl alcohol, ethylene glycol, and combinations thereof.

5. The conductive ink composition of claim 1, wherein the Ag-containing compound is present in an amount of from about 10 to 35 about wt %.

6. The conductive ink composition of claim 1, wherein the dispersion stabilizer is present in an amount of from about 2 to about 10 wt %.

7. The conductive ink composition of claim 1, wherein the solvent is present in an amount of from about 50 to about 80 wt %.

8. A method of producing a printed board, comprising:
coating a conductive ink composition on a substrate, the conductive ink comprising a Ag-containing compound, a dispersion stabilizer, and a solvent;
radiating electron beams on the substrate coated with the conductive ink composition; and
heat-treating the substrate radiated with electron beams.

9. The method of claim 8, wherein the electron beam has electron beam energy of from about 0.5 to about 0.7 MeV.

10. The method of claim 8, wherein the electron beam has a radiation amount of from about 30 to about 50 kGy.

11. The method of claim 8, wherein the heat treatment is performed at from about 190 to about 250° C.

12. The method of claim 8, wherein the Ag-containing compound is selected from the group consisting of AgCl, AgNO₃, AgClO₄, Ag₂SO₄, AgBF₄, CH₃COOAg, and combinations thereof.

13. The method of claim 8, wherein the dispersion stabilizer is selected from the group consisting of polyvinyl alcohol, polyvinyl pyrrolidone, polyethylene glycol, polyacrylic acid, and combinations thereof.

14. The method of claim 8, wherein the solvent is selected from the group consisting of water, ethanol, isopropyl alcohol, ethylene glycol, and combinations thereof.

15. The method of claim 8, wherein the Ag-containing compound is present in an amount of from about 10 to about 35 wt % in the conductive ink composition.

16. The method of claim 8, wherein the dispersion stabilizer is present in an amount of from about 2 to about 10 wt % in the conductive ink composition.

17. The method of claim 8, wherein the solvent is present in an amount of from about 50 to about 80 wt % in the conductive ink composition.

18. The method of claim 8, wherein heat-treating the substrate radiated with electron beams is performed from about 20 to about 40 minutes.

19. The method of claim 8, wherein the printed board comprises a flexible printed circuit (FPC).

20. The method of claim 8, wherein the Ag containing compound is AgNO₃.
